(19) United States
(12) Patent Application Publication
(10) Pub. No.: US 2026/0285606 A1
(43) Pub. Date: Sep. 24, 2026

(54) WIRELESS POWER MAGNETIC CLUTCH ASSEMBLY

(71) Applicant: Dematic Corp., Grand Rapids, MI (US)

(72) Inventor: Daniel J. Nowicki, Comstock Park, MI (US)

(21) Appl. No.: 19/480,285

(22) PCT Filed: May 6, 2024
(86) PCT No.: PCT/IB2024/054388

§ 371 Date: Oct. 30, 2025

Related U.S. Application Data
(60) Provisional application No. 63/500,093, filed on May 4, 2023.

(51) Int. Cl. B65G 23/08; H02K 49/10

(52) U.S. Cl. CPC B65G 23/08; H02K 49/108

(57) ABSTRACT

A magnetic clutch regulates rotational motion of a conveyor roller. A power transmission assembly with a transmission coil spaced from a receiving coil is energized to transfer energy from the transmission coil to the receiving coil. A clutch has a rotatably driven drive surface, and rotors magnetically coupled to stators. A shaft coaxially disposed along a longitudinal axis of the roller is coupled to rotors. The stators are coupled to the drive surface and are coupled to the receiving coil. The rotors become magnetically attracted to the stators to transfer rotational motion of the driving surface to the shaft and to a shell of the roller when energy is transferred to the stators in a first polarity direction.

### CROSS REFERENCE TO RELATED APPLICATION

The present application is a national stage application of International Patent Application No. PCT/IB2024/054388, filed May 6, 2024, and claims the priority benefits of U.S. provisional application, Ser. No. 63/500,093 filed May 4, 2023, which are hereby incorporated herein by reference in their entirety.

### FIELD OF THE INVENTION

The present invention is directed to a clutch assembly, and in particular, a wireless power magnetic clutch assembly that may assist in regulating the rotational motion of a conveyor roller in a frictionless manner, as well as providing electrical power and data information to devices external to the conveyor roller and/or portions of the conveyor roller.

### BACKGROUND OF THE INVENTION

Conveyance systems may include one or more conveyance assemblies, in which each conveyor assembly has one or more conveyor rollers. The conveyor rollers are driven, for example, via one or more drive belts, to rotate in a conveyance direction. An object, such as a package, may be placed into contact with one or more conveyor rollers while the conveyors are driven to rotate such that the package is conveyed in the conveyance direction. The rotational speed of the conveyor rollers may be regulated depending on various factors to optimize the conveyance of objects in the conveyance system. For example, one or more clutch assemblies may be incorporated into the conveyance system to assist in regulating the rotational motion of the conveyor rollers, in which the clutch assembly may include components that are selectively operable to physically or mechanically engage portions of the conveyor roller to cause rotation of the conveyor roller. The wear and tear associated mechanical/physical engagement between components may reduce the operational lifetime of these components.

### SUMMARY OF THE INVENTION

The present invention provides a frictionless clutch assembly or magnetic clutch assembly that may at least partially regulate the rotational speed of a conveyor roller, which may be part of a conveyor assembly for transporting packages and other articles. The magnetic clutch assembly includes a power transmission assembly that can wirelessly transfer energy over an air gap to a clutch assembly. The clutch assembly includes a rotor/stator assembly that can be selectively energized to create a repulsive or attractive magnetic field between the rotors and stators, and an outer driving surface that can be rotationally driven, for example, by a drive belt. When the attractive magnetic field is generated, the rotors become magnetically attracted to the stators, where the stators are part of and/or coupled to the driving surface. Rotational motion from the driving surface is transferred from the stators to the rotors, and in turn, to a center axle of the conveyor roller, thus causing the axle to rotate. The rotation of the axle is transferred to an interface that is coupled to the outer roller shell, thereby causing the outer roller shell to rotate. When the repulsive magnetic field is generated, the rotors become magnetically repelled from the stators to allow the stators/drive surface to rotate freely with respect to the rotors/axle. Thus, the magnetic clutch assembly is operable to selectively assist in the rotation of the conveyor roller, or to allow for the substantially uninhibited and/or unassisted rotation of the conveyor roller, without physically, mechanically, or otherwise frictionally engaging rotational portions of the conveyor to regulate the rotational motion of the conveyor roller.

According to one form of the present invention, a magnetic clutch assembly for use in regulating rotational motion of a conveyor roller in a conveyor assembly includes a power transmission assembly having a transmission coil spaced from a receiving coil, the transmission coil may be energized to wirelessly transfer energy to the receiving coil. A clutch assembly includes a driving surface configured to be rotatably driven, a first rotor that may be magnetically coupled to a first stator, a second rotor that may be magnetically coupled to a second stator, and a shaft coaxially disposed along a longitudinal axis of the conveyor roller and coupled to the first and second rotors. The first and second stators are coupled to the driving surface and are electrically coupled to the receiving coil. The first and second rotors become magnetically attracted to the first and second stators, respectively, via a magnetic attracting force. The magnetic attraction between the rotors and stators transfers the rotational motion of the driving surface to the axle and the outer roller shell of the conveyor roller. The magnetic attraction between the rotors and stators is produced when energy is transferred to the first and second stators in a first polarity direction.

In one aspect, the first and second rotors become magnetically repelled by the first and second stators via a magnetic repelling force to allow the first and second stators and the outer roller shell of the conveyor roller to rotate freely with respect to one another. The magnetic repelling force is produced when energy is transferred to the stators in a second polarity direction. Optionally, the magnetic repelling force is approximately equal to a natural magnetic attraction force between the rotors and the stators.

In another aspect, the first rotor includes a first magnetic pole end cap coupled at a first magnetic pole portion a permanent magnet, and the second rotor comprises a second magnetic pole end cap coupled at a second magnetic pole portion of the permanent magnet.

In yet another aspect, the first stator includes multiple first stator coils about which one or more electrical conductors are wound in a first direction, and the second stator includes multiple second stator coils about which one or more electrical conductors are wound in a second direction opposite the first direction.

In still another aspect, a control system controls the magnitude and polarity of energy transferred to the first and second stators. Optionally, the control system has a full bridge rectifier. The control system may include a pulse width modulator to turn on and off the energy being supplied to the first and second stators, thereby controlling the average magnitude of energy being supplied to the first and second stators. The control system may also include a host microprocessor and a power switch, where the host microprocessor may control the power switch to output either a high voltage energy signal or a low voltage energy signal. A communication system may transmit an electronic signal to the host microprocessor such that the host microprocessor controls the power switch to output either the high voltage energy signal or the low voltage energy signal based on the electronic signal received from the communication system. Optionally, the control system includes an H-bridge electrical circuit that may adjust the polarity of the energy transferred from the receiving coil to the first and second stators between the first and second polarity directions. A clutch microprocessor may adjust the H-bridge to output energy in either the first or second polarity direction based on whether the clutch microprocessor detects the high voltage or the low voltage. Optionally, the clutch microprocessor adjusts the H-bridge to output energy in the first polarity direction when the high voltage is detected, and to output energy in the second polarity direction when the low voltage is detected.

In a further aspect, the transmission coil and the receiving coil are spaced apart by an air gap.

In another aspect, a clutch assembly includes an exemplary wireless power transfer device having a transmitter (TX) unit located on a first section, a receiver (RX) unit located on a second section, and a barrier separating the first section from the second section. The wireless power transfer device provides power to the RX unit without having to wire connect the TX unit to the RX unit.

In one aspect, the wireless power transfer device further provides power to the RX unit which is in communication with a working system positioned within the conveyor roller. Optionally, the RX unit also communicates with other devices located outside the conveyor roller.

In another aspect, the wireless power transfer device provides data and control signals to the RX unit, portions of the conveyor roller, and devices positioned within the conveyor roller or located outside the conveyor roller, or combinations thereof.

In a further aspect, the transmitted input data signals are provided to a controller that is either encapsulated within the conveyor roller or positioned outside the conveyor roller. The input data signals are transmitted from one or more devices. The data signals may include operational signals, sensor signals, and the like.

In one aspect, the TX unit is a primary coil, and the RX unit is a secondary coil. Antennas may be coupled to the primary coil and the secondary coil respectively. The wireless power transfer device may transfer and provide power transmission using near-field technique, far-field technique, resonant inductive coupling, capacitive coupling, or other suitable techniques. The barrier is either an air gap, a separator, or an insulator.

In a further aspect, an exemplary working system includes a memory, a controller, a brake, a clutch device, and a sensor assembly, and so forth, which are collectively formed as the working system. The working system is positioned within the conveyor roller.

In one aspect, the second section positioned within the wireless power transfer device extends into an area for which the working system is located.

In another aspect, a third section separate from the second section is formed and the working system is positioned within the third section.

Accordingly, the magnetic clutch assembly of the present invention may regulate the rotational motion of a conveyor roller in a frictionless manner such that wear and tear associated with regulating rotational motion of a conveyor roller via mechanical/frictional engagement is reduced, thus potentially increasing the longevity of various components associated with the conveyor roller. A power transmission assembly wirelessly transfers power to a clutch assembly, in which the clutch assembly may be selectively energized to create a repelling or attractive magnetic field between rotors and stators. When magnetically coupled via the attractive magnetic field, the rotational motion of the stators—coupled to a driving surface that is rotatably driven—is transferred to the magnetically coupled rotors. The rotational motion of the rotors is then transferred to a centrally-located axle of the conveyor roller, which in turn transfers the rotational motion to a roller shell of the conveyor roller. When the rotors are magnetically repelled, the stators/roller shell are able to rotate freely with respect to the rotors.

These and other objects, advantages, purposes and features of this invention will become apparent upon review of the following specification in conjunction with the drawings.

### BRIEF DESCRIPTION OF THE DRAWINGS

FIG. 1 is a top plan view of a conveyor assembly having a plurality of conveyor rollers equipped with magnetic clutch assemblies in accordance with the present invention;

FIG. 2 is an end perspective view a magnetic clutch assembly in accordance with the present invention;

FIG. 3 is a side perspective view of the magnetic clutch assembly of FIG. 2 where portions of the magnetic clutch assembly are transparent to reveal additional details;

FIG. 4 is another side perspective view of the magnetic clutch assembly of FIG. 2, where a pair of stators have been removed to reveal a pair of rotors;

FIG. 5 is a rotated side perspective view of the magnetic clutch assembly of FIG. 4, shown coupled to the conveyor roller;

FIG. 6 is an end elevation view of the magnetic clutch assembly of FIG. 2;

FIG. 7 is a cross sectional view of the magnetic clutch assembly of FIG. 2;

FIG. 8 is a side perspective exploded view of the magnetic clutch assembly of FIG. 2, where various components have been removed to reveal additional detail;

FIG. 9 is another side perspective view of the magnetic clutch assembly of FIG. 2, where end caps have been removed to reveal power transmission coils and bearing assemblies;

FIG. 10 is an end perspective view of a clutch assembly of the magnetic clutch assembly of FIG. 2;

FIG. 11 is a side perspective exploded view of the clutch assembly of FIG. 10;

FIG. 12 is a perspective exploded view of stators and rotors of the clutch assembly of FIG. 10 representing by color a winding direction of electrical conductors around stator coils of the stators, and further showing a top plan view of each rotor labeled with “N” and “S” to represent the magnetic polarity of each rotor;

FIG. 13 is an electrical circuit diagram of a pair of coils spaced apart by an air gap and being capable of wirelessly transferring energy between one another;

FIG. 14 is an upper perspective view of a pair of coils that may be incorporated into an electrical assembly to wirelessly transfer energy between one another;

FIG. 15 is a diagrammatic representation of a control system of the magnetic control assembly of FIG. 2;

FIG. 16A is an electrical circuit diagram of an H-bridge electrical circuit in a configuration to transfer energy in a first polarity direction;

FIG. 16B is an electrical circuit diagram of the H-bridge electrical circuit of 16A shown in a configuration to transfer energy in a second polarity direction;

FIG. 17 is a graph representing voltage as a function of time, in which the voltage is adjusted via pulse width modulation, such that a wide pulse width results in a higher average voltage as compared to a narrower pulse width;

FIG. 18 is a graph representing an exemplary pulse width modulation and its effect on a voltage waveform;

FIG. 19 is a graph representing an exemplary 90% duty cycle versus a 50% duty cycle over a same period length;

FIG. 20 is a graph illustrating the use of frequency modulation to encode information on an output waveform;

FIG. 21 is an electrical circuit diagram showing a simplified representation of a wireless energy transmission circuit;

FIG. 22 shows an exemplary wireless power receiver circuit board;

FIG. 23A is an electrical circuit diagram representing an integrated circuit for a wireless energy relay coil where the circuit does not include protection in the form of a transient voltage suppressor against voltage spikes as a result of wireless transfer of a pulsed electrical signal;

FIG. 23B is a graph representing the voltage characteristics of the electrical signal resulting from the circuit of FIG. 23A;

FIG. 24A is another electrical circuit diagram identical to the electrical circuit of FIG. 23A, but with the addition of a transient voltage suppressor;

FIG. 24B is a graph representing the voltage characteristics of the electrical signal resulting from the circuit of FIG. 24A;

FIG. 25A is an electrical circuit diagram of an alternative integrated circuit for a wireless energy relay coil where the circuit includes a collapsing magnetic field energy capture circuit; and

FIG. 25B is a graph representing the voltage characteristics of the electrical signals resulting from the electrical circuit diagram of FIG. 25A.

### DESCRIPTION OF THE PREFERRED EMBODIMENTS

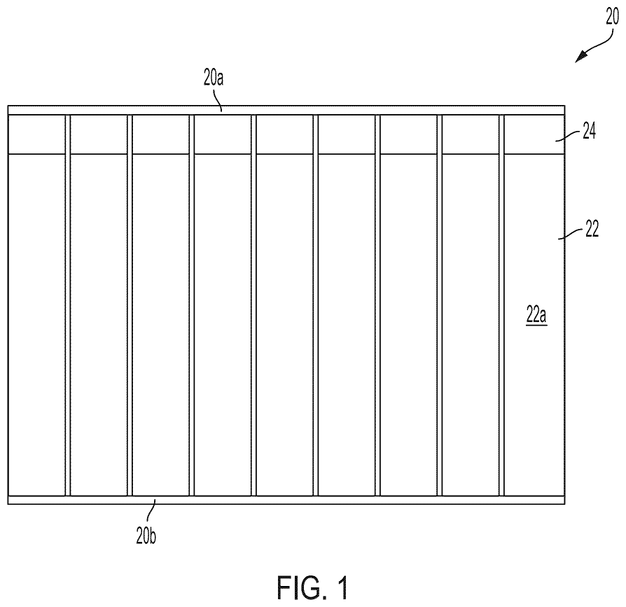

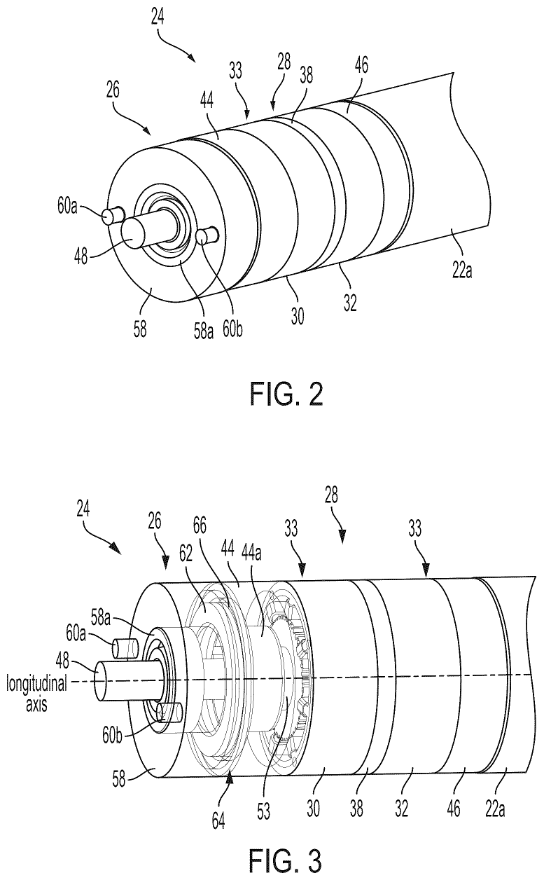

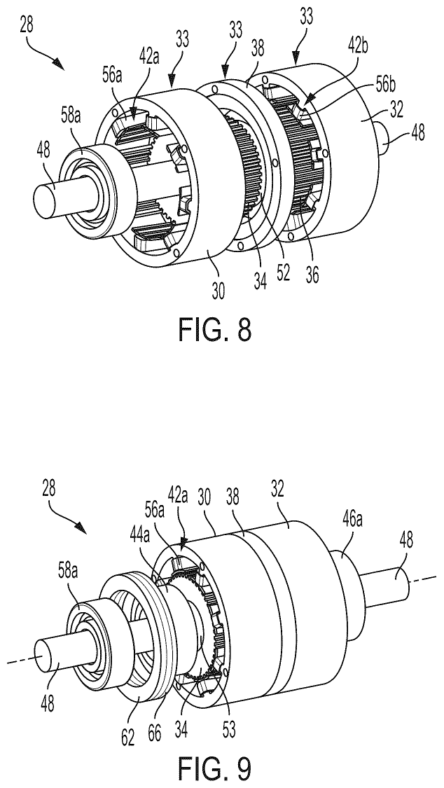

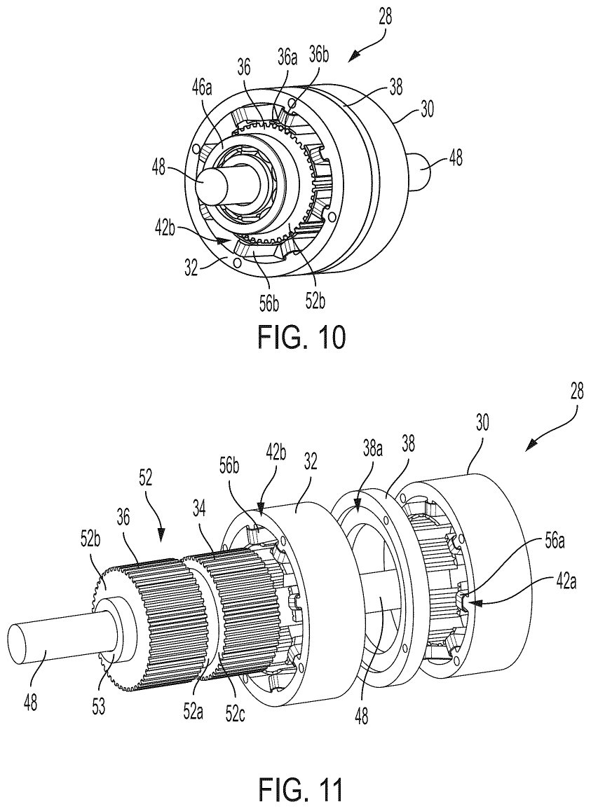

The present invention will now be described with reference to the accompanying figures, wherein the numbered elements in the following written description correspond to like-numbered elements in the figures. With reference to FIG. 1, a conveyor assembly 20, which may be part of a larger conveyance system, is used for conveying objects, such as packages, and includes a number of conveyor rollers 22 operably coupled between opposing side walls 20a, 20b. Each conveyor roller 22 includes an outer roller shell 22a that is configured to rotate in a conveyance direction. The rotational motion of each conveyor roller 22 may be regulated, at least in part, by a frictionless clutch assembly or wireless magnetic clutch assembly 24 that includes a power transmission assembly 26 and a clutch assembly 28 (FIGS. 2-12). Clutch assembly 28 includes first and second stators 30, 32 that are not in direct physical contact with, but partially surround, respective first and second rotors 34, 36. Stators 30, 32 are also coupled to a driving surface 33 such that stators 30, 32 rotate substantially synchronously with driving surface 33. Clutch assembly 28 may be selectively energized via power transmission assembly 26 to cause the magnetic attraction or repulsion between rotors 34, 36 and stators 30, 32, where the stator windings are not in opposition to create repulsive and attractive fields, but are wired in the same direction to provide universal attractive fields when power is applied and universal repulsive fields when power is reversed. The rotational motion of stators 30, 32 and/or driving surface 33 may be transferred to rotors 34, 36 while rotors 34, 36 are magnetically attracted to stators 30, 32. The rotational motion of rotors 34, 36 is then transferred to a center axle of conveyor roller 22, where the rotational motion of the axle is further transferred to roller shell 22a via an interface fit 50 that is frictionally engaged with shell 22a. Stators 30, 32 and roller shell 22a are able to freely rotate relative to rotors 34, 36 while rotors 34, 36 are magnetically repelled from stators 30, 32. Clutch assembly 28 is wirelessly energized via power transmission assembly 26 such that clutch assembly 28 is freely rotatable relative to power transmission assembly 26.

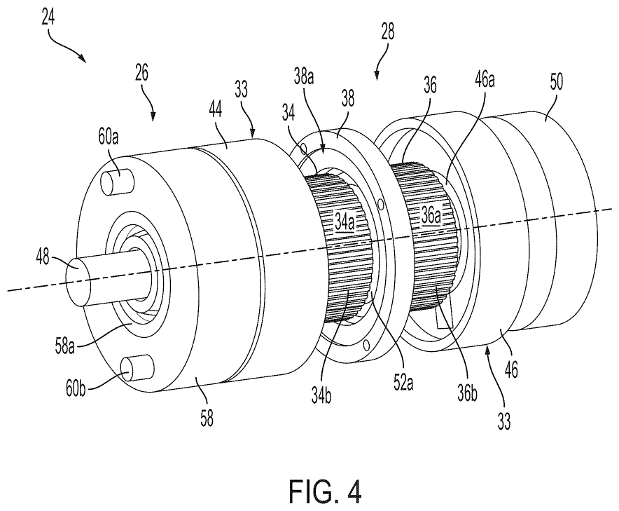

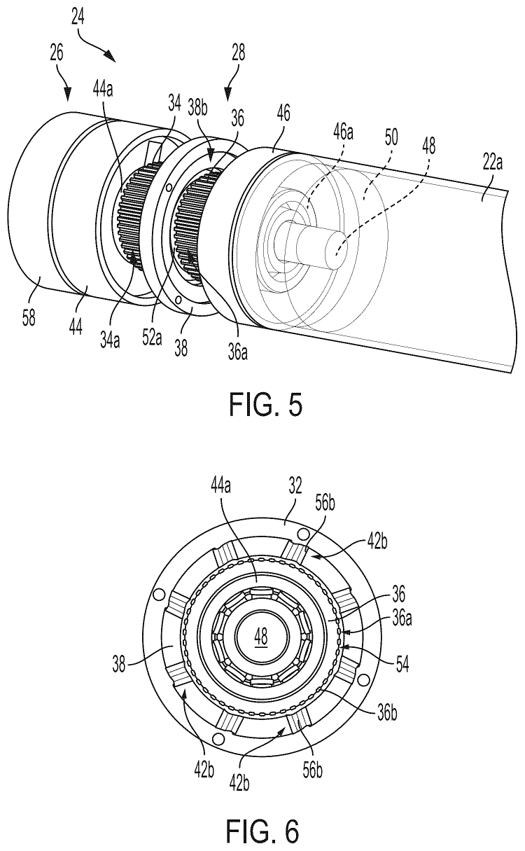

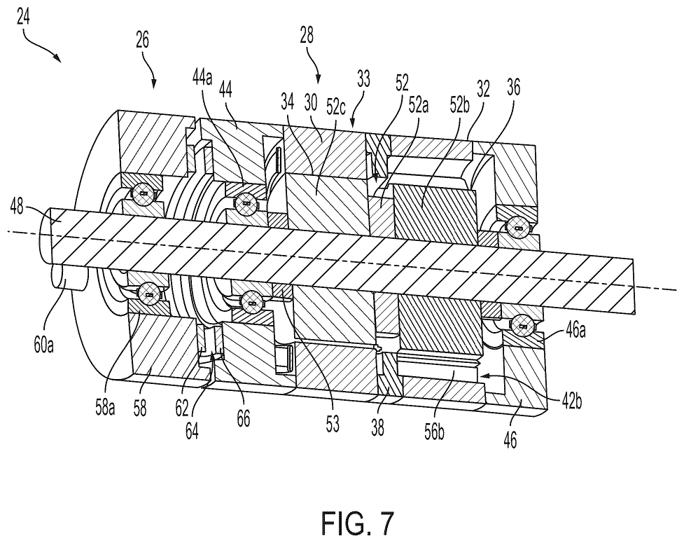

With reference to FIGS. 2-12, magnetic clutch assembly 24 includes clutch assembly 28 that is energizable to regulate the rotation of roller shell 22a of conveyor roller 22 via selective magnetic coupling, including to allow roller shell 22a to rotate substantially uninhibited or to provide rotational force to roller shell 22a to assist or facilitate the rotation of roller shell 22a. Clutch assembly 24 includes first stator 30 that is spaced from second stator 32 by a spacer 38. With particular reference to FIGS. 4-5, 7-8, and 11, opposing sides of spacer 38 located adjacent stators 30, 32 include recessed portions 38a, 38b that accommodate the spatial requirements of electrical windings 40a, 40b around stator coils 42a, 42b of stators 30, 32. Each stator 30, 32 is coupled to roller shell 22a of conveyor roller 22 such that stators 30, 32 rotate with or synchronously with roller shell 22a. A pair of end caps 44, 46 at outboard sides of stators 30, 32 provide support to clutch assembly 28, and include internal bearing assemblies 44a, 46a (FIGS. 7 and 9) that couple end caps 44, 46 to an axle 48 of conveyor roller 22 that is coaxially aligned with a longitudinal axis of roller 22. Bearing assemblies 44a, 46a support axle 48 while also enabling axle 48 to rotate relative to end caps 44, 46. With reference to FIG. 5, interface fit 50 is coupled to roller shell 22a via press fit and/or frictional engagement, and is further coupled to axle 48 such that interface fit 50 rotates with axle 48. Because axle 48 needs to be able to freely rotate, axle 48 should be coupled to side walls 20a, 20b of conveyor assembly 20 via round holes rather than hex holes or other holes with polygonal geometry. Rotors 34, 36 are at least partially surrounded in an outward radial direction from stators 30, 32, while also being physically spaced in an inward radial direction from stators 30, 32, thus allowing for the rotation of rotors 34, 36 relative to stators 30, 32 and vice versa. Axle 48 passes through a center of each rotor 34, 36, and is coupled to rotors 34, 36 such that axle 48 rotates with or synchronously with rotors 34, 36.

With reference to FIGS. 4-5, 7-8, and 11, each rotor 34, 36 includes an outer portion 34a, 36a or annular-shaped ring having numerous teeth 34b, 36b, in which outer portions 34a, 36a are circumferentially coupled at opposing side or end portions of a permanent magnet 52 having a first and second magnetic poles 52b, 52c, which may correspond to a magnetic north pole located opposite a magnetic south pole, or vice versa. Outer portions 34a, 36a are made of a ferromagnetic material, and thus, are magnetically coupled to permanent magnet 52 such that each outer portion 34a, 36a takes on the magnetic characteristics associated with the portion of permanent magnet 52 they are coupled at. Outer portions 34a, 36a also include or define a number of rotor teeth 34b, 36b that protrude radially outwardly from outer portions 34a, 36a. Therefore, outer portion 34a is associated with the first magnetic pole, while outer portion 36a is associated with the second magnetic pole. A central portion 52a of permanent magnet located between the magnetic poles of permanent magnet 52 is magnetically neutral. A pair of spacers 53 are also located adjacent outboard sides of each rotor 34, 36 to provide support and alignment for rotors 34, 36.

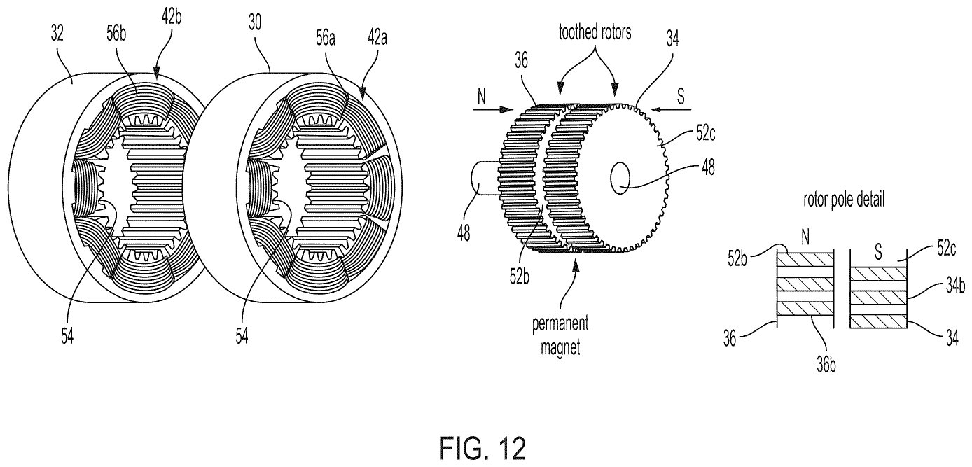

As noted above, stators 30, 32 partially surround or overlie rotors 34, 36 in an outer radial direction. To accommodate rotors 34, 36 in this fashion, each stator 30, 32 resembles a ring or annular-shaped object having inner and outer radial surfaces/sides. On the inward radial sides adjacent rotors 34, 36, each stator 30, 32 includes sets of spaced-apart stator coils 42a, 42b projecting or extending further radially inward towards rotors 34, 36, where each stator coil 42a, 42b is made of a ferromagnetic material and includes a series of radially inwardly facing stator teeth 54 also made of a ferromagnetic material. In the illustrated embodiment, each stator 30, 32 includes eight stator coils 42a, 42b, however, it should be appreciated that a stator could have more or less stator coils. An elongated electrical conductor or wire 56, such as a copper wire, is wrapped or wound around each stator coil numerous times 42a, 42b. With reference to FIG. 12, first stator coils 42a include wire 56a that is wrapped or coiled around each stator coil 42a in a first direction, for example a clockwise as viewed from FIG. 12, while second stator coils 42b include a wire 56b that is wrapped or coiled around each stator coil 42b in a second direction opposite the first direction, for example, a counterclockwise direction as viewed from FIG. 12. Each wire 56a, 56b is capable of carrying an electrical current transferred or transmitted to clutch assembly 28 via power transmission assembly 26. Thus, in contrast to a conventional stepper motor having electrical windings in alternating direction with respect to adjacent stator coils, the windings or wires 56a, 56b are in the same direction to thereby provide universal attractive fields when power is applied at a first polarity or direction (e.g. positive to negative) and universal repulsive fields when the polarity or direction of the power is reversed.

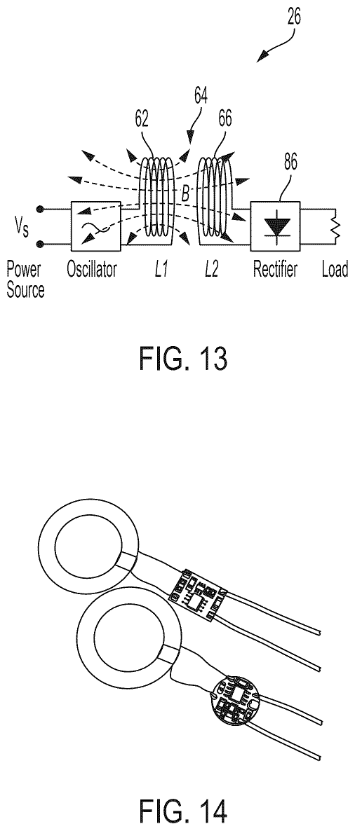

Power transmission assembly 26 includes an external housing 58 that is coupled in a fixed position to side channels or walls 20a, 20b of conveyor assembly 20 via a pair of engagement pins 60a, 60b protruding outwardly from external housing 58. It should be appreciated that an external housing may be mounted to side walls of a conveyor assembly in alternative manners as well. An internal bearing assembly 58a allows for axle 48 to rotate freely with respect to external housing 58. An inductive coil or transmission coil 62 (which may be considered a “primary coil”) is located within external housing 58, and is spaced apart via an air gap 64 from another inductive coil in the form of receiving coil 66 (which may be considered a “secondary coil”). With reference to FIG. 13, and as will be described in more detail below, transmission coil 62 is capable of wireless transferring energy or electricity across air gap 64 to receiving coil 66. Air gap 64 allows for the free rotation of portions of clutch assembly 28, for example driving surface 33, relative to power transmission assembly 26. Alternatively, the air gap may be a separator or an insulator, such that a barrier is provided therebetween the transmission coil 62 and the receiving coil 66. In one embodiment, the operational energy requirements of magnetic clutch assembly could be approximately 24 V and 0.5 A, but this amount may vary depending on torque limits and power requirements. Additionally significant magnetic torque coupling between stators 30, 32 and rotors 34, 36 may occur at 5 V 500 mA (2.5 watts).

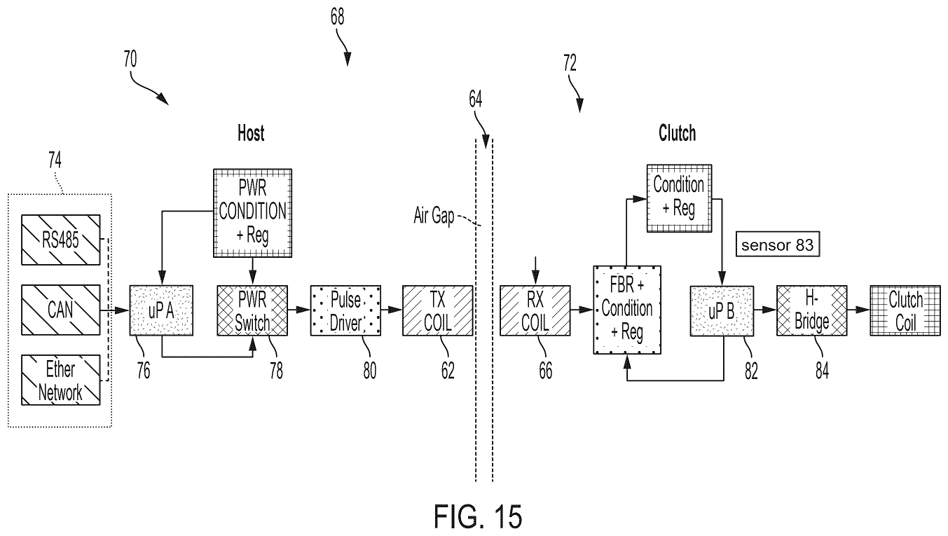

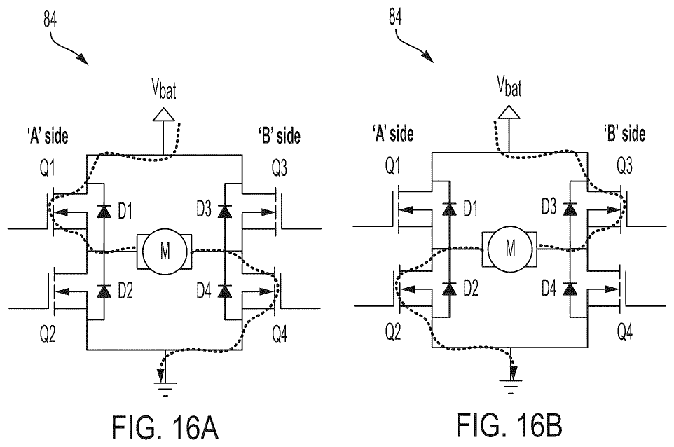

With reference to FIG. 15, a control system 68 operable to control the magnitude and polarity of energy transfer between one or more of power transmission assembly 26, clutch assembly 28, and/or the various components thereof, includes two circuit boards in the form of a host control 70 primarily used to regulate power, interact with a communications system 74, and regulate wireless power transmission; and a clutch control 72 primarily used to regulate electrical polarity in clutch assembly 28. Communication network or system 74, for example using RS485, Controller Area Network (CAN), or an Ether based network (such as Profinet, Ethernet/IP or TCP/IP communications) may send and receive data and other signals to a host controller 76, which may be a low voltage microprocessor or metal-oxide-semiconductor field-effect transistor (MOSFET) that receives signals from communication system 74, where the signals are used to determine various electrical characteristics outputted by power transmission assembly 26. In particular, an electrical input, such as an alternating current (AC) electrical wave or signal is conditioned and regulated appropriately in order to power host controller 76. For example, the electrical signal may be conditioned and regulated to conform to traditional required power for switching systems and low voltage microprocessor systems, such as an incoming power of 24 Volts Direct Current (VDC) to 48 VDC, while also undergoing transient voltage suppression and regulated 3.3V for host controller 76.

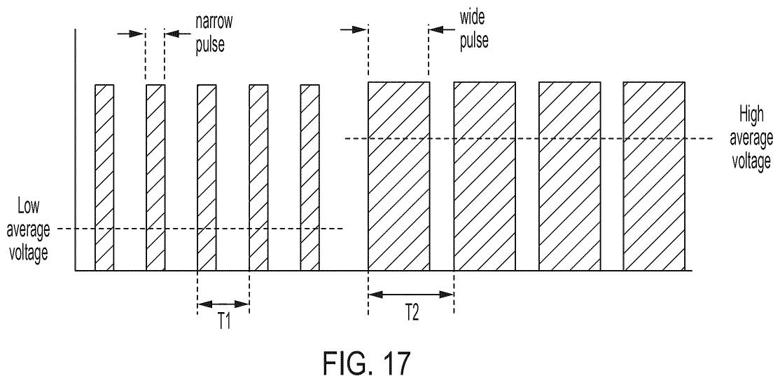

Host controller 76 controls a power switch 78 to allow an electrical signal and/or electricity to run to a pulse driver 80. Host controller 76 uses a native Pulse Width Modulation (PWM) driver to send a pulse driver 80 which varies the duty cycle or frequency of the electrical signal based on data from communication system 74 (FIGS. 17-20). As shown in FIG. 17, the electrical signal undergoes PWM such that it is turned on and off at varying time intervals to achieve an “average” voltage output as desired. The electrical signal is then further transmitted/transferred to transmission coil 62, which is an inductive coil with an electrical conductor or wire wound around a ferromagnetic core (see FIGS. 13 and 15). Transmission coil 62 radiates energy in a magnetic field that is tuned to the length and number of turns of the electrical conducting wire on transmission coil 62 and receiving coil 66. As noted above, coils 62, 66 do not come in physical contact with one another, but still couple with one another the same way a traditional transformer having a single and common ferromagnetic core does. In this way, coils 62, 66 are able to couple respective magnetic fields through a non-contact space or air gap 64 to transfer power/energy wirelessly. The use of ferromagnetic materials as discussed above may improve the overall efficiency of magnetic clutch assembly 28 while also reducing radiated electromagnetic noise. In one embodiment, exemplary power transmission may be provided using near-field technique, far-field technique, resonant inductive coupling, capacitive coupling, or other suitable techniques.

After energy transmission from transmission coil 62 to receiving coil 66, a full bridge rectifier 86 is used to convert alternating current (AC) to direct current (DC), while the electrical signal is also once again conditioned and regulated at clutch control 82 to provide the needed capacitance to stabilize the rectified energy and to provide a regulated 3.3 VDC, which may be appropriate for host controller 76. (FIG. 15). The clutch controller 82, which may be similar in many respect to host controller 76, opens and closes switches in an H-Bridge electrical circuit 84 to adjust the electrical signal polarity being sent to stators 30, 32. The basis of which switches in H-bridge 84 to open/close is determined by signals received from host control 70, or more specifically, host controller 76, which will be described in further detail below. To illustrate, the electrical signal may flow or run through and exit H-bridge 84 in a first polarity direction by closing a pair of switches as shown in FIG. 16A, while the electrical signal may flow or run through and exit H-bridge 84 in a second polarity direction by closing an alternative pair of switches.

After exiting H-bridge 84 with a certain polarity, as discussed above, the electrical signal is received by stators 30, 32. Specifically, electricity runs through wires 56a, 56b that are wound or wrapped around stator coils 42a, 42b. If the electrical signal is in the state of or running in the first polarity direction, an attractive magnetic field is generated between stators 30, 32 and rotors 34, 36. Alternatively, if the electrical signal is in the state of or running in the second polarity direction, a repulsive or repelling magnetic field is generated between stators 30, 32 and rotors 34, 36.

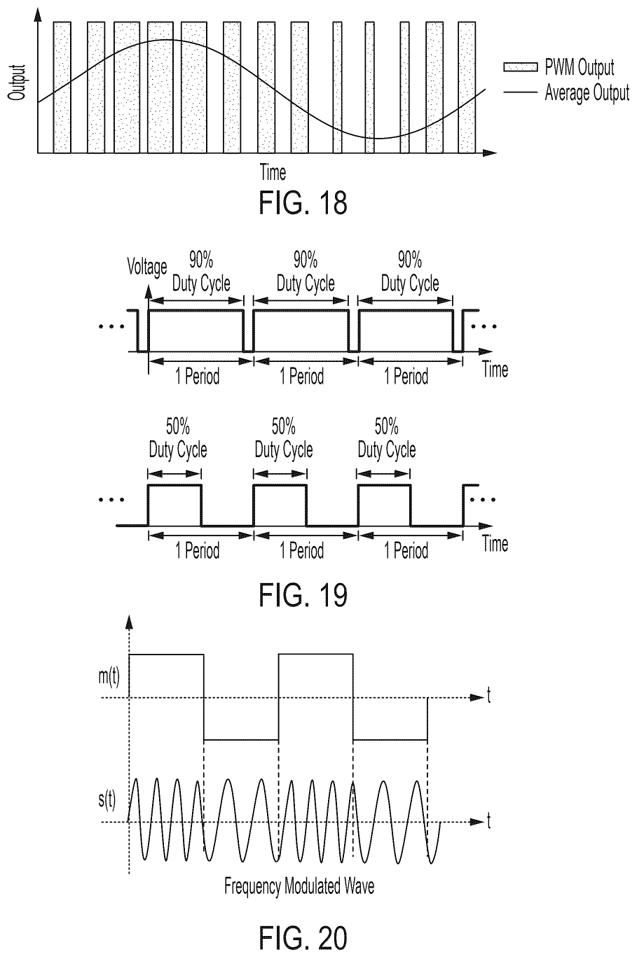

When the attractive magnetic field is generated, stators 30, 32 and rotors 34, 36 become magnetically attracted to one another. As noted above, stators 30, 32 are coupled to or may form all or at least part of driving surface 33, which is driven to rotate via a drive belt or the like. Once magnetically coupled, at least some of the rotational motion of stators 30, 32 is transferred to rotors 34, 36, thus causing rotors 34, 36 to rotate without making physical and/or mechanical contact with stators 30, 32 or any portion of drive surface 33. The rotational motion of rotors 34, 36 is transferred to axle 48, which as noted above is coupled to rotors 34, 36, thus causing axle 48 to also rotate. As previously discussed, axle 48 is coupled to interface fit 50 such that the rotation of axle 48 further causes the rotation of interface fit 50. Interface fit 50 is frictionally engaged with roller shell 22a to thereby further transfer rotation to shell 22a. In this way, the rotation of driving surface 33 is able to be transferred to shell 22a via frictionless clutch engagement. In other words, when the attractive magnetic field is generated, stators 30, 32 are magnetically coupled to an armature (rotors 34, 36 and/or axle 48) and both rotate. However, by using Pulse Width Modulation (PWM), the amount of torque coupled to rotors 34, 36 and axle 48 can be modified (see FIGS. 17 and 18). For example, a reduction in the duty cycle of the PWM causes the amount of torque coupled to the rotors 34, 36 and axle 48 to be reduced.

Alternatively, when the repulsive or repelling magnetic field is generated, stators 30, 32 and rotors 34, 36 become repelled from one another. As previously discussed, rotors 34, 36 are coupled to permanent magnet 52, where even when stators 30, 32 are in a de-energized state, permanent magnet 52 is magnetically attracted to the laminated steel of stators 30, 32 (known as “cogging torque”). Accordingly, the cogging torque must be overcome to allow for the free rotation of driving surface 33 relative to rotors 34, 36, axle 48, interface fit 50, roller shell 22a, etc. Thus, the repulsive magnetic field generated is substantially equal to magnetic field that produces the cogging torque in order to negate and/or lessen the torque transferred magnetically between stators 30, 32 and rotors 34, 36. As such, while the repulsive magnetic field is present, the overall net torque between stators 30, 32 and rotors 34, 36 is zero or approximately negligible to allow for the unimpeded or unrestrained rotation of stators 30, 32 and driving surface 33 relative to rotors 34, 36. In other words, in the when the repulsive/repelling magnetic field is generated, stators 30, 32 repel rotors 34, 36. However, PWM may be used in this state to vary the amount or magnitude of the repulsive field, as only the inherent attraction of permanent magnet 52 to the laminated steel of stators 30, 32 must be negated. This reversal into a repulsive state allows axle 48 and/or rotors 34, 36 to freely rotate with respect to stators 30, 32 and/or driving surface 33 without the cogging torque produced due to permanent magnet 52.

As noted above, the strength of the attractive and repulsive magnetic fields may be varied by control system 68 as desired to achieve a certain degree of torque coupling between stators 30, 32 and rotors 34, 36. For example, if more rotational motion is desired to be transferred from clutch assembly 28 to roller shell 22a, a higher duty cycle via PWM may be executed. Alternatively, if a lesser amount of rotational motion is desired to be transferred from clutch assembly 28 to roller shell 22a, a lower duty cycle PWM may be executed. It should be appreciated that other electrical characteristics may also be modified to achieve desired levels or torque between stators 30, 32 and rotors 34, 36 to result in a desired amount of rotational motion that is transferred to roller shell 22a.

As discussed above, clutch controller 82 controls which switches in H-bridge 84 are open and closed to output the electrical signal in either the first polarity direction or the second polarity direction based on signals received from host control 70, or more specifically, host controller 76. There are a number of ways in which signals could be wireless sent or conveyed, including across air gap 64 as part of the electrical signal, to indicate which switches in H-bridge 84 should be opened and closed. In one method, “ON/OFF” signals can be communicated to clutch controller 82 in various ways to indicate the desired electrical polarity to be sent to stators 30, 32. For example, clutch controller 82 could measure the incoming power as a voltage (via a sensor of the clutch controller 82, or a separate sensor (e.g., sensor 83), in which a high or higher voltage would indicate to engage the clutch assembly 28 (generate the attractive magnetic field via the electrical signal being in a first polarity direction or state), while a low or lower measured voltage could indicate to disengage clutch assembly 28 (generate the repulsive/repelling magnetic field via the electrical signal being in the second polarity direction or state) to allow for the substantially free rotation of driving surface 33 and/or stators 30, 32. If advanced diagnostics or communications are required, it is possible to signal using a modified version of this design with a slight increase in cost/complexity.

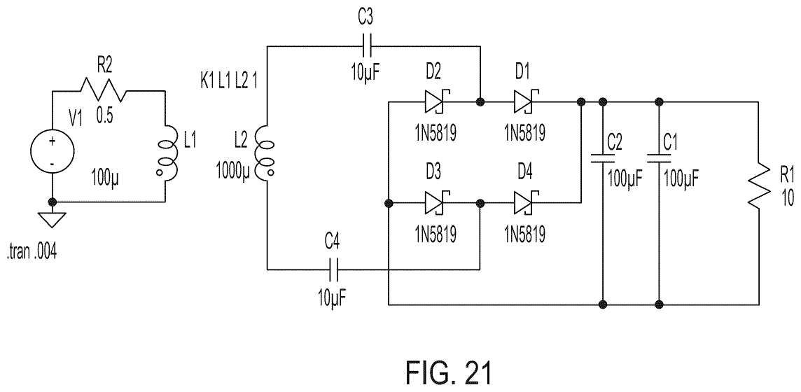

It should be appreciated that there are various other ways to send signals between host controller 76 and clutch controller 82 to achieve desired electrical characteristics of an electrical signal that is being sent to stators 30, 32. For example, in one method a variation of the duty cycle of Pulse Driver 80 of host control 70, and the subsequent monitoring of the resultant voltage at clutch control 72, for example via clutch controller 82, may be used. With reference to FIG. 21, by this modulation, clutch controller 82 may monitor the accumulated and/or average voltage level measured at capacitors C1 or C2 (via a voltage sensor, e.g., sensor 83), and use the measurements of “High” and “Low” voltages to provide signaling for clutch engagement and disengagement (“freewheeling”). A second method involves duty cycle monitoring, in which clutch controller 82 is capable of measuring the duty cycle of the incoming electrical pulse before the electrical signal is rectified via full bridge rectifier 86. In one embodiment, the clutch controller 82 utilizes the output of a sensor (e.g., sensor 83) to calculate or measure the duty cycle. With reference to FIG. 21, the duty cycle could be between diodes D2 and D1. By shifting the duty cycle, clutch controller 82 can detect the change and use this to adjust H-bridge 84 to thereby adjust electrical polarity, all while variation in the voltage at clutch control 72 and/or clutch assembly 28 is minimized. A third method is through pulse frequency modulation, in which the use of frequency modulation allows for more information to be communicated over air gap 64 via power transmission assembly 26 while maintaining a constant voltage at clutch control 72 and/or clutch assembly 28 (see FIG. 20). Referring again to FIG. 21, the frequency modulation could again be measured (via sensors, e.g., sensor 83) between diodes D2 and D1.

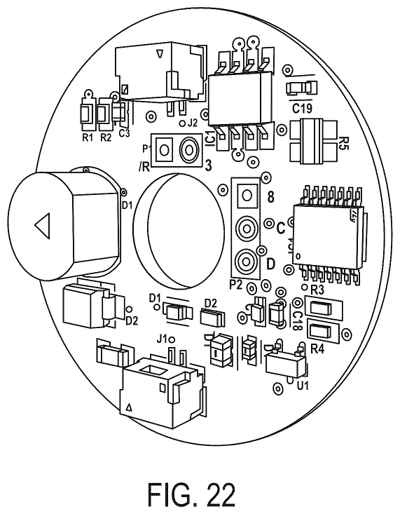

Referring now to FIG. 22, an exemplary wireless power receiver is shown that includes an integrated circuit (IC) for wireless power transmission. The IC provides functionality and flexibility in regards to coupling with and/or accommodating different wireless power transmission systems. However, currently the majority of wireless power systems are designed for cellphone and other wireless devices that have relatively low power operating requirements, while many other wireless power systems are designed for relatively high power requirements, for example, wireless charging an electric vehicle.

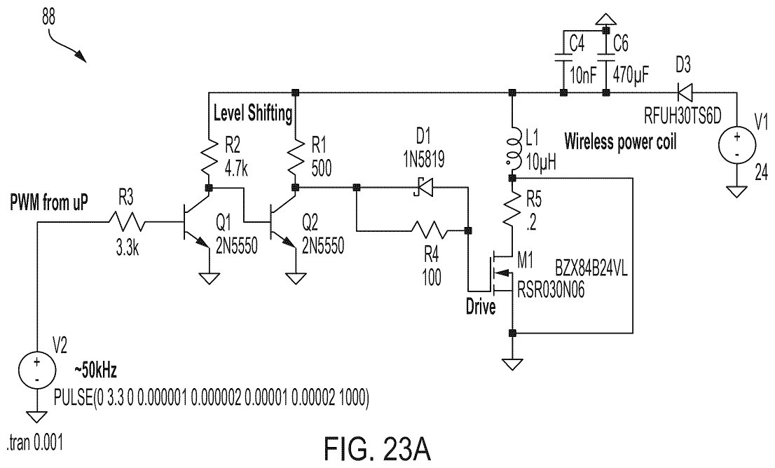

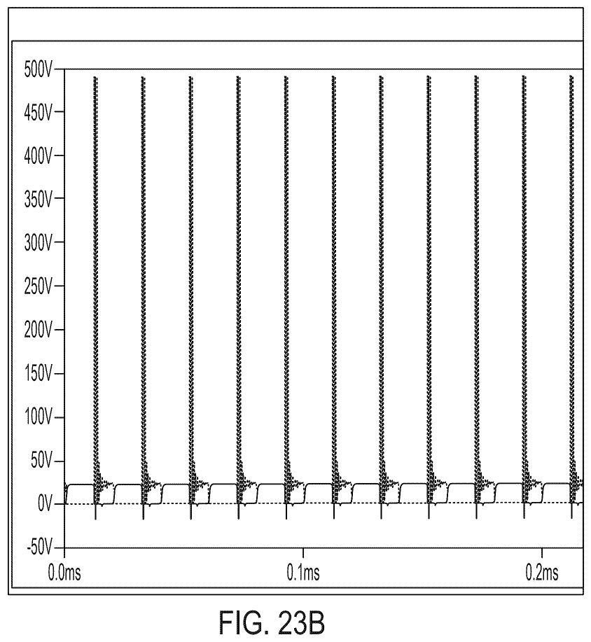

With reference to FIG. 23A, a circuit diagram representing an integrated circuit (IC) 88 for a wireless energy relay coil is shown. Of note, IC 88 does not include any protection against voltage spikes resulting from the interplay between voltage spike, for example due to PWM, and the resulting magnetic flux, for example in the air gap between induction coils. The resulting voltage characteristics of IC 88 are shown in FIG. 23B, where the spikes of the dashed line represent each time the wireless relay coil receives a voltage/energy pulse. As the energy signal switches to the “off” state (between pulses), the magnetic field associated with the coil (L1) collapses and causes electrical current to flow. Because there is no path to ground to “Clamp” out this power, a high voltage spike is generated, which is represented by the thick line. This high voltage spike can damage or destroy a MOSFET, so appropriate measures should be taken to prevent voltage spikes of this nature to ensure electrical components operate as designed.

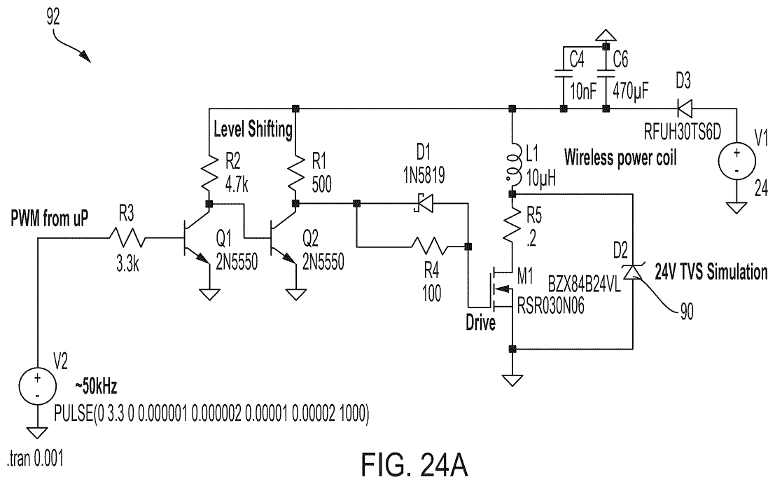

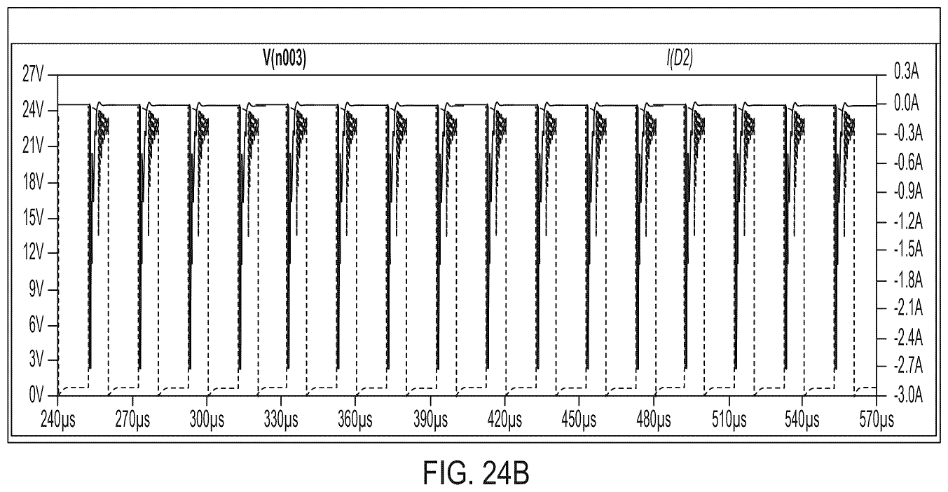

A transient voltage suppressor diode 90 (TVSD 90) may be incorporated into IC 88 to mitigate and/or prevent the voltage spikes discussed above. FIG. 24A shows an IC 92 that is identical to IC 88, but with the addition of TVSD 90. The incorporation of TVSD 90 into IC 92 controls the voltage spikes discussed above by running or clamping to electrical ground the excess voltage. FIG. 24B shows the resulting electrical characteristics of IC 92, where the dashed waveform represents the voltage measured between L1 and R5, while the solid, thick waveform represents the current measured through the TVSD 90. While the use of TVSD 90 is a relatively simple way to remove undesired voltage spikes and provide protection to sensitive electrical components, such as a MOSFET, a temporally short but significant amount of energy may be lost or wasted by clamping the electrical signal to ground in this fashion.

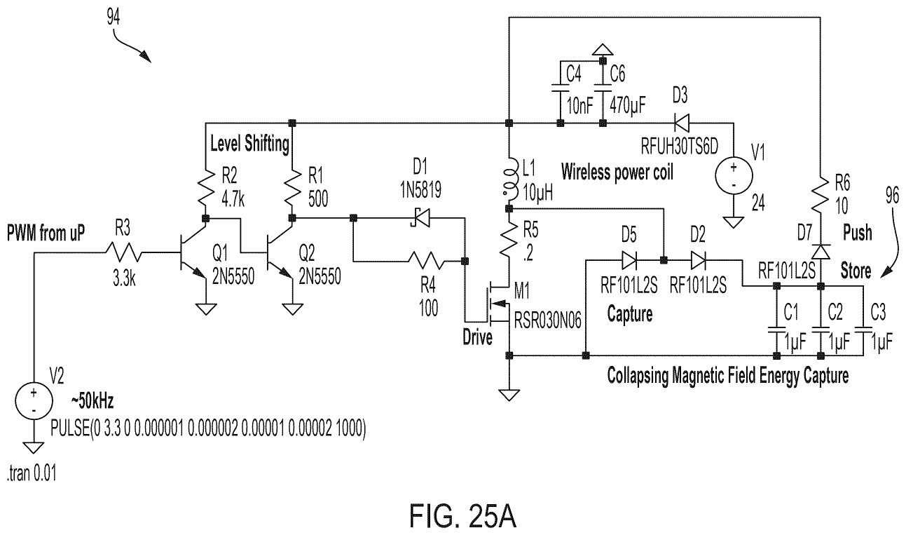

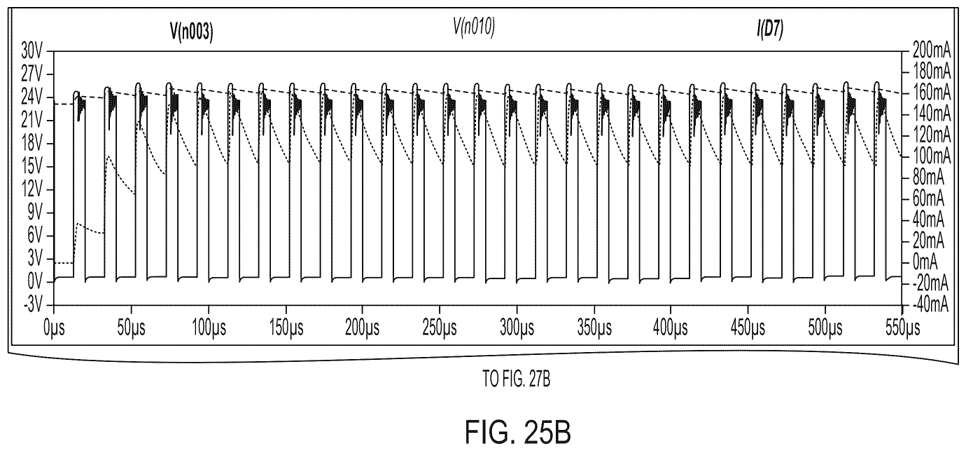

Referring now to FIG. 25A, an alternative electrical circuit diagram representing an alternative IC 94 for a wireless energy relay coil is shown, where the circuit includes a collapsing magnetic field energy capture circuit 96. When a voltage spike occurs, the voltage spike passes through diode D2 and is stored in capacitors C1, C2, and C3. This attenuates the voltage spike and also captures and accumulates the energy associated with the voltage spike. As these spikes are short, capacitors C1, C2, C3 begin to charge and filter the voltage spikes, thus increasing the voltage across capacitors C1, C2, C3. Once capacitors C1, C2, and C3 have captured sufficient energy such that the voltage across capacitors C1, C2, and C3 reaches a sufficient voltage, for example 0.7 V (or higher than the supplied power V1 0.7), diode D7 will conduct the discharging the current from capacitors C1, C2 and C3. Accordingly, the energy associated with the voltage spikes is captured and recirculated increasing the overall efficiency of the switching system. Thus, IC 94 may effectively attenuate voltage spikes resulting from pulsed electrical signals and/or the resulting magnetic flux associated with wireless energy transfer to protect various electrical components, such as the components of control system 68 previously discussed, while also capturing the energy associated with the voltage spikes to improve efficiency. This can be seen with reference to FIG. 25B, in which the solid line of FIG. 25B represents the voltage across coil L1, while the dashed line of FIG. 25B represents the voltage on capacitors C1, C2, and C3. The dotted line of FIG. 25B represents the power through diode D7 that was captured from capture circuit 96, and that is subsequently re-introduced or directed back into the power system. Specifically, the simulation of IC 94 shown in the waveforms of FIG. 25B shows that with each pulse 90 mA to 160 mA of energy is reintroduced into the positive side of power system. Thus, IC 94 with capture circuit 96 provides a method to reuse energy that would otherwise be wasted.

Thus, in one exemplary embodiment, a wireless power transfer device 26 comprises a power transmitter (TX) unit (e.g., transmission coil 62) located in a “first section,” a receiver (RX) unit (e.g., receiving coil 66) located in a “second section,” and with a barrier separating the first section from the second section. In one exemplary embodiment, the barrier is an air gap (e.g., air gap 64). The wireless power transfer device 26 provides power to the RX unit (e.g., receiving coil 66) without requiring a physical electrical connection between the TX unit and the RX unit. In one exemplary embodiment, the TX unit (e.g., transmission coil 62) is a primary coil, and the RX unit (e.g., receiving coil 66) is a secondary coil. Antennas may be coupled to the primary coil and the secondary coil respectively. The wireless power transfer device may transfer and provide power transmission using near-field technique, far-field technique, resonant inductive coupling, capacitive coupling, or other suitable techniques. The barrier is either an air gap, a separator, or an insulator.

As described herein, the wireless power transfer device 26 is configured to provide power to the RX unit (e.g., receiving coil 66), which is in communication with a “working system” positioned within the conveyor roller. Optionally, the RX unit (e.g., receiving coil 66) also communicates with other devices located outside the conveyor roller 22. An exemplary working system can include, for example, a memory, a controller (e.g., clutch control 70 and/or clutch controller 82), a brake, a clutch device, and a sensor assembly, and so forth, which are collectively formed as the working system. The working system is positioned within the conveyor roller.

In one embodiment, the second section (the RX unit or receiving coil 66) positioned within the wireless power transfer device extends into an area for which the working system is located. Alternatively, a third section separate from the second section is formed and the working system is positioned within the third section. That is, the RX unit may be integrated with or separate from the clutch control system 72.

As also discussed herein, the wireless power transfer device 26 is configured to provide data and control signals to the RX unit (e.g., receiving coil 66), portions of the conveyor roller (e.g., clutch control 72 and clutch controller 82), and devices positioned within the conveyor roller 22 (e.g., components of clutch control 72) or located outside the conveyor roller 22, or combinations thereof (other controllers, sensors, etc.).

The wireless power transfer device 26 may also be configured to transmit input data signals, which, for example, can be provided to a controller that is either encapsulated within the conveyor roller 22 or positioned outside the conveyor roller 22 (e.g., control signals from the host control 70 or host controller 76 wirelessly communicated across the air gap 64 to indicate to the clutch control 72 and/or clutch controller 82 which switches in H-bridge 84 should be opened and closed). Thus, the input data signals can be transmitted by the wireless power transfer device 26 to one or more devices. The data signals may thus include operational signals, sensor signals (e.g., voltage sensors of (or coupled to) the clutch controller 82, e.g., sensor 83), and the like.

It should be appreciated that various aspects of what has been described above with regard to magnetic clutch assembly 24 may vary while still remaining within the scope of the present invention. With regard to clutch assembly 28, various components could vary in geometry and design while still achieving the functionality discussed above. For example, more or less stators and/or rotors could be implemented into a clutch assembly, and the stators and rotors used could have more or less stator and/or rotor teeth, could include more or less stator coils, and could have electrical windings that are wrapped or wound around the stator coils more or less times and in varying directions apart from what has been previously described. Additionally, the transference of rotational motion from the rotors may be achieved through alternative mechanical linkages, in which the motion is transferred without an axle through an alternative mechanical connection, or possibly an additional magnetic connection via additional stators and rotors.

With regard to the power transmission system, an air gap may be bigger or smaller from what is shown in the illustrated embodiments, in which the size of the inductive coils or the electrical characteristics of the coils (such as the number of times a wire is wound around a ferromagnetic core) could vary. Furthermore, power could alternatively be transferred through a direct physical electrical connection. For example, traditionally power delivery is done with a carbon brush and a shaft that provides contacts and wiring. However due to the shape, application and need for proper weight distribution and balancing, a brushed system may not be idea for use in a frictionless or magnetic clutch assembly. Additionally, carbon brushes need to be replaced over time. Furthermore, a magnetic clutch assembly may not require large power requirements that may require direct electrical connections, as the magnetic coupling and the short distance between the stators and the armature generally only requires a few watts to provide significant torque transfer.

With regard to the control system, many variations in the number, type, and characteristics of the electrical components may vary to achieve the above-discussed functionality of control system 68. For example, an alternative control system may adjust an electrical signal in an alternative fashion without the use of PWM, or may vary the polarity of an electrical signal through other known methods that don't use an H-bridge electrical circuit. Additionally, other methods may also be available to regulate/mitigate voltage spikes resulting from power transmission apart from what has been described above.

Electrification and integration of a frictionless or magnetic clutch system into a conveyor roller assembly allows for the modification, if not removal, of a significant amount of moving mechanical componentry along with a second power source, being pneumatics (in which pneumatic power may be used to drive/actuate various mechanical components). As discussed above, a frictionless clutch assembly could be operated via electrical power, signaling methods, and guiding a drive belt to drive the outer shell or driving surface of the clutch assembly. This system allows for relatively easy integration into programmable logic controls (PLC's), and the system may also be signaled with relatively basic I/O cards, serial communications, or Ether based networking protocols. Additionally, a magnetic clutch system similar or identical to what has been described herein may be used in other applications, and is not limited to roller conveyor assembly. That is, substantially anywhere a mechanical clutch is used, this design could also be used.

In contrast, conventional clutches may involve a lot of friction to operate, thus potentially causing unwanted wear and tear on various components in a conveyor assembly. The most simplistic representation of a conventional clutch could be summarized as pushing a spinning disc into a second disc to cause the second disc to rotate. In this scenario, until the speeds of a driven shaft and a driving shaft are matched there is heat generation, material loss and variations of torque, and these mechanical devices are subject to reduced efficiency associated with friction.

Accordingly, a frictionless magnetic clutch assembly couples the rotational energy from a driven rotational surface to a roller shell or other surface of a conveyor roller desired to be rotatably drive, without physical/mechanical interaction. By placing a consistent or pulsed energy to a stator, the stator becomes coupled to an armature to provide torque coupling without making components physically engage one another. Additionally, there are no moving parts outside the general rotation of the driven portion of the clutch system. By reversing a magnetic field, the magnetic clutch system negates the native magnetic drag between the stator and the armature, thus allowing for these components to rotate substantially freely relative to one another. Additionally, the use of wireless power transfer methods allows basic communication to an onboard controller and the required power to couple or negate the magnetic field of the frictionless clutch, while also removing the need for brushes or other types of rotational power transfer systems. Thus, the cost, complexity and degenerative effect on various components that may be associated with a conventional clutch assembly may be avoided. As noted above, the magnetic clutch system also allows for advanced PLC integration by allowing for networking or discrete control based on desires, increasing the automation of the system, reaction, control precision, or simplification of wiring.

Changes and modifications in the specifically described embodiments can be carried out without departing from the principles of the present invention which is intended to be limited only by the scope of the appended claims, as interpreted according to the principles of patent law including the doctrine of equivalents.

1. A magnetic clutch assembly for use in regulating rotational motion of a conveyor roller in a conveyance system, said magnetic clutch assembly comprising:
a power transmission assembly comprising a transmission coil spaced from a receiving coil, said transmission coil configured to be energized to wirelessly transfer energy to said receiving coil; and
a clutch assembly comprising a drive surface configured to be rotatably driven, a first rotor configured to be magnetically coupled to a first stator, a second rotor configured to be magnetically coupled to a second stator, and a shaft coaxially disposed along a longitudinal axis of the conveyor roller and coupled to said first and second rotors, said first and second stators coupled to said drive surface and electrically coupled to said receiving coil;
wherein said first and second rotors become magnetically attracted to respective said first and second stators via a magnetic attracting force to impart rotational motion of said driving surface to said shaft and to an outer roller shell of the conveyor roller when energy is transferred to said first and second stators in a first polarity direction.

2. The magnetic clutch assembly of claim 1, wherein said first and second rotors become magnetically repelled by said first and second stators via a magnetic repelling force to allow said first and second stators and the outer roller shell of the conveyor roller to rotate freely with respect to one another when energy is transferred to said first and second stators in a second polarity direction.

3. The magnetic clutch assembly of claim 2, wherein said magnetic repelling force is approximately equal to a natural magnetic attraction force between said first and second rotors and said first and second stators.

4. The magnetic clutch assembly of claim 1, wherein said first rotor comprises a first magnetic pole end cap coupled at a first magnetic pole portion to a permanent magnet, and said second rotor comprises a second magnetic pole end cap coupled at a second magnetic pole portion of said permanent magnet.

5. The magnetic clutch assembly of claim 1, wherein said first stator comprises a plurality of first stator coils about which one or more electrical conductors are wound in a first direction, and wherein said second stator comprises a plurality of second stator coils about which one or more electrical conductors are wound in a second direction opposite the first direction.

6. The magnetic clutch assembly of claim 5, further comprising a control system configured to control the magnitude and polarity of energy transferred to said first and second stators.

7. The magnetic clutch assembly of claim 6, wherein said control system further comprises a full bridge rectifier.

8. The magnetic clutch assembly of claim 6, wherein said control system further comprises a pulse width modulator (PWM) configured to turn on and off the energy being supplied to said first and second stators to control the average magnitude of energy being supplied to said first and second stators.

9. The magnetic clutch assembly of claim 8, wherein said control system further comprises a host microprocessor and a power switch, said host microprocessor configured to control said power switch to output either a high voltage energy signal or a low voltage energy signal.

10. The magnetic clutch assembly of claim 9, further comprising a communication system configured to transmit an electronic signal to said host microprocessor, wherein said host microprocessor controls said power switch to output either the high voltage energy signal or the low voltage energy signal based on the electronic signal received from said communication system.

11. The magnetic clutch assembly of claim 6, wherein said control system further comprises an H-bridge electrical circuit configured to adjust the polarity of the energy transferred from said receiving coil to said first and second stators between the first and second polarity directions.

12. The magnetic clutch assembly of claim 11, wherein said control system further comprises a clutch microprocessor configured to adjust said H-bridge electrical circuit to output energy in either the first or second polarity direction based on whether said clutch microprocessor detects the high voltage or the low voltage.

13. The magnetic clutch assembly of claim 12, wherein said clutch microprocessor adjusts said H-bridge electrical circuit to output energy in the first polarity direction when the high voltage is detected, and wherein said clutch microprocessor adjusts said H-bridge electrical circuit to output energy in the second polarity direction when the low voltage is detected.

14. The magnetic clutch assembly of claim 4, wherein said transmission coil and said receiving coil are spaced apart by an air gap.

15. The magnetic clutch assembly of claim 8, wherein a duty cycle associated with the PWM may be selectively varied to adjust the strength of the magnetic field between said stators and said rotor.

16. A magnetic clutch assembly for use in regulating rotational motion of a conveyor roller in a conveyance system, said magnetic clutch assembly comprising:
a power transmission assembly configured to be energized to transfer energy; and
a clutch assembly comprising a drive surface configured to be rotatably driven, and a rotor configured to be magnetically coupled to a stator, said stator coupled to said drive surface and electrically coupled to said power transmission assembly;
wherein said rotor becomes magnetically attracted to said stator via a magnetic attracting force to impart rotational motion of said driving surface to an outer roller shell of the conveyor roller when energy is transferred to said stator in a first polarity direction.

17. The magnetic clutch assembly of claim 16, wherein said rotor become magnetically repelled by said stator via a magnetic repelling force to allow said stator and the outer roller shell of the conveyor roller to rotate freely with respect to one another when energy is transferred to said stator in a second polarity direction.

18. The magnetic clutch assembly of claim 16, wherein said clutch assembly comprises a controller for controlling a polarity direction and magnitude of the energy transferred to said stator.

19. The magnetic clutch assembly of claim 16, wherein said power transmission assembly is configured to transmit energy and data to said clutch assembly for energizing and controlling said clutch assembly.

20. The magnetic clutch assembly of claim 19, wherein the data comprises operational signals and/or sensor signals.
